(19) United States
(12) Patent Application Publication
(10) Pub. No.: US 2005/0229812 A1
(43) Pub. Date: Oct. 20, 2005

(54) Clay containing lignocellulose and the method for forming the same

(76) Inventor: Chin-Chi Lee, Taipei County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/006,057

(22) Filed: Dec. 7, 2004

(30) Foreign Application Priority Data
Apr. 20, 2004 (TW) 093110912

(51) Int. Cl. C08L 89/00

(52) U.S. Cl. 106/137.1

(57) ABSTRACT

The present invention discloses a clay that contains lignocellulose and the method for forming the same. The provided clay has, adding to traditional malleability of clay, ability to be carved and drilled like wood when processed. Moreover, the provided clay is able to show natural wood texture after being dried. To sum up, the provided clay contains features of both clay and wood, and is hard and bears crashes after being dried. Therefore, aside from being used as material for art works, the provided clay can also be used as material for construction patches and industrial molds. Further, the provided clay is mainly made of natural, organic raw materials, thus is easy to discompose after use and cause the least harm to nature.

### BACKGROUND OF THE INVENTION

1. Field of the Invention

This invention relates to a clay and the method for forming the same, and more particularly, to a clay containing lignocellulose and the method for forming the same.

2. Description of the Prior Art

Clay is formed by rocks being in weathering over a long time, scattering on the earth over, being a kind of sculptured material with popular prices, and is inexhaustible in supply as well. The rocks have different minerals and different weathering levels, clay varieties are thus various. The different clay varieties have different hues. Their colors mainly depend on themselves contained oxides and organic matters. Usually, the clay with a lighter color has poor adhesion. For the moment, the widespread clay varieties can be classified into as followings:
1. Paper clay: the paper clay is a common clay, being made of the mixture of paper pulp and paste, and is white and soft. During its shaping process, the oven-baking step is unnecessary. After being dried, the texture of the paper clay is between clay and gypsum, the paper clay at this stage could be colored or dyed to show plentiful colors, and is easy to be sculptured. Due to its low price, the paper clay is quite popular. However, its texture after being dried is quite fragile, its adhesion is poor, and its weight is quite heavy.
2. Light weight clay: the light weight clay is a synthetic clay with soft texture and good adhesion, and has a lithe weight like cloth or cotton. During its shaping process, the oven-baking step is unnecessary. The light weight clay is easy to sculpture and can bear crashing after being dried. However, its texture after being dried is fragile, and its price is quite expensive. Moreover, since the light weight clay is made through synthesis processes and contains many chemical compositions, it could cause environmental pollutions after use.
3. Clay flour is made of crumbs and resin, and possesses a lighter weight. In its shaping process, the oven-baking step is unnecessary. After being dried, the clay flour is easy to sculpture but cannot bear crashing. Since the clay flour has amylum element, it could mold and breed flies if the clay flour is not processed suitably.
4. Polymer clay: the polymer clay is a thermosetting oil clay being made of clay varieties of different colors, and is not sticky to hands. During its shaping process, the polymer clay needs a low temperature oven-baking step. After this step, the final product can adhere to materials such as cloth, wood, metal, glass, and so forth. Moreover, the final product is not easily out of shape and can be reserved, also has the waterproof feature and is not easily damaged. However, the chemical compositions contained in the polymer clay are easily to be released out during the low temperature oven-baking step. This causes the environmental poison.
5. Pot clay: the pot clay is the rawest clay and can be classified as thermosetting clay. During its shaping process, the pot clay needs a high temperature oven-baking step. After this step, the final product can be glazed. However, its texture is fragile.

The well-known clay varieties mentioned above possess plasticity, but they still cannot show the carving feature and plastic feature simultaneously. Also, most clay varieties are made of the synthetic clay containing chemical compositions that are easily absorbed by human bodies and are harmful to those art workers. Further, the chemical additives or petrochemical materials make the synthetic clay difficultly decayed and decomposed spontaneously. This not only pollutes the environment, but also affects the ecological environment deeply.

In view of the drawbacks mentioned with the prior art of clay, there is a continued need to develop a new and improved clay that overcomes the disadvantages associated with the prior art of clay. The advantages of this invention are that it solves the problems mentioned above.

### SUMMARY OF THE INVENTION

In accordance with the present invention, a clay containing lignocellulose is provided that substantially obviates one or more of the problems resulted from the limitations and disadvantages of the prior art mentioned in the background.

The present invention provides a clay containing lignocellulose and the method for forming the same. The present invention makes the clay have the feature of wood through mixing the lignocellulose from farm products to form the clay containing lignocellulose. The provided clay does not need the oven-baking step during its shaping process, and only has a few chemical compositions since it is mostly made of natural organic compounds. Moreover, after being shaped, its texture is hard and not fragile. Besides, the hues and hardness of the provided clay can be adjusted to meet practical needs. Thus, the present invention meets economical benefits and industrial uses.

As described above, the present invention discloses a clay containing lignocellulose and the method for forming the same. The constituent elements of the present invention include a filler containing lignocellulose, a soft material containing amylum, an adhesive, a hardness-adjusting agent, and a hue-adjusting agent. The present invention firstly provides a first feed containing lignocellulose, a second feed containing soft material, a third feed containing powdery adhesive, and a fourth feed containing clay. The above-mentioned feeds are mixed through a powdering process to form a powder. Then, a first blending process is carried out to blend the powder mentioned above with the hardness-adjusting agent and the hue-adjusting agent to form an admixture. After the first blending process, a second blending process is carried out to blend the admixture mentioned above with an adhering agent and a moisture-adjusting agent to form the provided clay containing lignocellulose.

### DESCRIPTION OF THE PREFERRED EMBODIMENT

Some embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

In one embodiment of the present invention, a first feed containing lignocellulose, a second feed containing soft material, a third feed containing powdery adhesive, and a fourth feed containing clay are provided in a powdering process to form a powder. Wherein, the powdering process further includes a grinding process to grind the first feed, the second feed, the third feed, and the fourth feed, individually. However, the amount of the fourth feed can depend on practical needs, and in some cases can even be zero. The first feed containing lignocellulose mentioned above is the material having plenty of plant fiber, and is selected from the following group: unhusked rice, straw, bagasse, wood flour, paper pulp, herbage, and the mixture thereof . . . , etc. Herein, the first feed is about 40%-65% weight of the resulted powder, and the preferred content is 50%. The second feed containing soft material mentioned above has plenty of amylum, and is selected from the following group: cassava, flour, glutinous rice, and the mixture thereof . . . , etc. Herein, the second feed is about 30%-40% weight of the resulted powder, and the preferred content is 35%. The third feed containing powdery adhesive mentioned above is selected from the following group: glycuronic acid, polysaccharides, hyaluronic acid, and the mixture thereof . . . , etc. Herein, the third feed is more than 7% weight of the resulted powder, and the preferred content is 14%. The fourth feed containing clay mentioned above is selected from the following group: china clay, pot clay, brick flour, rock flour, and the mixture thereof . . . , etc. Besides, the powder is about 55%-65% gross weight of the provided clay, and the preferred content is 60%.

In this embodiment, a first blending process is carried out to blend the above-mentioned powder with a hardness-adjusting agent and a hue-adjusting agent to form an admixture. The hardness-adjusting agent can make the provided clay spontaneously get hard, through which to adjust the hardness of the final-shaped provided clay, and has inorganic substances containing calcium, such as calcium hydroxide or calcium oxide. Herein, the hardness-adjusting agent is less than 3% gross weight of the provided clay and the preferred content is 1%. The hue-adjusting agent can make the hue of the provided clay lighter or darker, through which to adjust the color of the final-shaped provided clay, and has an agent for adjusting acid-alkali, such as carbonate, calcium carbonate, hydroxide, calcium hydroxide, and acid. Herein, the hue-adjusting agent is less than 5% gross weight of the provided clay, and the preferred content is 2%. However, the first blending process and the blended elements can depend upon practical needs, and in some cases the first blending process can even be omitted.

In this embodiment, after the first blending process, a second blending process is carried out to blend the admixture mentioned above with an adhering agent and a moisture-adjusting agent to form a clay containing lignocellulose. The adhering agent is employed to strengthen the adhesion function of the third feed containing powdery adhesive, and further includes a resin material, such as natural rubber, a material containing amylum and a surfactant with both lipophile and hydrophile, such as glycerin. Herein, the adhering agent is formed through the follow steps: mixing the material containing amylum with a heated liquid to form a mixture, herein the temperature of the heated liquid is prefer to be 70-90 degrees centigrade; adding the resin material and the surfactant with both lipophile and hydrophile into the mixture and making them well mixed to form the adhering agent. The moisture-adjusting agent is used to accelerate the moisture evaporation to control the shaping time of the provided clay. The moisture-adjusting agent could be acetic acid, sodium carbonate, calcium hydroxide, and ethanol. Herein, the adhering agent is about 35%-45% gross weight of the provided clay, and the preferred content is 40%; the moisture-adjusting agent is less than 2% gross weight of the provided clay, and the preferred content is 1%.

In this embodiment, the elements of the provided clay containing lignocellulose are individually described as followings: (1) a first feed that contains lignocellulose is about 24%-39% gross weight of the provided clay, and the preferred content is 30%. Herein, the first feed is the material having plenty of plant fiber, and is selected from the following group: unhusked rice, straw, bagasse, wood flour, paper pulp, herbage, and the mixture thereof . . . , etc. (2) a second feed that contains soft material is about 18%-24% gross weight of the provided clay, and the preferred content is 21%. Herein, the second feed has plenty of amylum, and is selected from the following group: cassava, flour, glutinous rice, and the mixture thereof . . . , etc. (3) a third feed that contains powdery adhesive is more than 4% gross weight of the provided clay, and the preferred content is 8%. Herein, the third feed is selected from the following group: glycuronic acid, polysaccharides, hyaluronic acid, and the mixture thereof . . . , etc. (4) a fourth feed that contains clay is about 0%-30% gross weight of the provided clay. Herein, the fourth feed is selected from the following group: china clay, pot clay, brick flour, rock flour, and the mixture thereof . . . , etc. However, the amount of the fourth feed can depend upon practical needs, and in some case can even be zero. (5) a hardness-adjusting agent makes the provided clay spontaneously get hard, through which to adjust the hardness of the final-shaped provided clay, being about 0%-3% gross weight of the provided clay and the preferred content is 1%, and has inorganic substances containing calcium, such as calcium hydroxide or calcium oxide. Herein, the amount of the hardness-adjusting agent can depend upon practical needs, and in some cases can even be zero. (6) a hue-adjusting agent is about 0%-5% gross weight of the provided clay, and the preferred content is 2%, and has an agent for adjusting acid-alkali, such as calcium carbonate or carbonate, calcium hydroxide, hydroxide, acid. Herein, the amount of the hue-adjusting agent can depend upon practical needs, and in some cases can even be zero. (7) an adhering agent is employed to strengthen the adhesion function of the third feed, being about 35%-45% gross weight of the provided clay and the preferred content is 40%, and further has a resin material, such as natural rubber, a material containing amylum and a surfactant with both lipophile and hydrophile, such as glycerin. (8) an moisture-adjustin agent is about 0%-2% gross weight of the provided clay, and the preferred content is 1%, and is used to accelerate the moisture evaporation. For example, acetic acid, sodium carbonate, calcium hydroxide, and ethanol are all suitable moisture-adjusting agent of the present invention.

As mentioned above, the present invention uses the hardness-adjusting agent, the hue-adjusting agent, and the adhering agent to auxiliarly form the provided clay. Further, the ratios of the above-mentioned agents depend upon practical needs in order to have the carving, plastic, and coloring features of the provided clay. Moreover, the present invention employs the moisture-adjusting agent to control the shaping time of the provided clay. Besides, the provided clay can dry naturally, and does not need any oven-baking process. This saves the shaping time and the energy cost. Moreover, since the provided clay has plenty of lignocellulose to make its density like wood, it shows the features of wood, such as being lighter and harder in comparison with normal clay. In another aspect, the elements of the provided clay are from the naturals, which are easily decomposed spontaneously, so the provided clay will not poison the environment. To sum up, the provided clay can meet economical benefits and industrial uses. Apart from being used as clay materials for art works, the provided clay can also be used as patching materials for any constructions, such as wood buildings or furniture. Additionally, the provided clay with lignocellulose added has not been on the market by far.

Although specific embodiments have been illustrated and described, it will be obvious to those skilled in the art that various modifications may be made without departing from what is intended to be limited solely by the appended claims.

1. A method for forming a clay that contains lignocellulose, said method comprising:
providing a first feed that contains lignocellulose, a second feed that contains a soft material, and a third feed that contains powdery adhesive;
performing a powdering process to blend said first feed with said second feed and said third feed to form a powder; and
performing a blending process to blend said powder with an adhering agent and a moisture-adjusting agent to form said clay, wherein said adhering agent is utilized to enhance the adhesion function of said third feed, and said moisture-adjusting agent is used to accelerate moisture evaporation to control the shaping time of said clay.

2. The method according to claim 1, wherein said first feed is 40%-65% of said powder by weight.

3. The method according to claim 1, wherein said second feed is 30%-40% of said powder by weight, and said soft material in said second feed has plenty of amylum.

4. The method according to claim 1, wherein said third feed is more than 7% of said powder by weight.

5. The method according to claim 1, wherein said powdering process further includes mixing a fourth feed that contains a clay material to form said powder, said fourth feed is selected from the following group: china clay, pot clay, brick flour, rock flour, and the mixture thereof.

6. The method according to claim 1, wherein said powder after said powdering process is blended with a hardness-adjusting agent that makes said clay spontaneously get hard, through which to adjust the hardness of said clay, said hardness-adjusting agent is less 3% of said clay by weight.

7. The method according to claim 1, wherein said powder after said powdering process is further blended with a hue-adjusting agent that makes the hue of said clay lighter or darker, through which to adjust the color of said clay, said hue-adjusting agent is less than 5% of said clay by weight.

8. The method according to claim 1, wherein said adhering agent is 35%-45% of said clay by weight.

9. The method according to claim 1, further comprising a method for forming said adhering agent which comprises:
mixing a material containing amylum with a heated liquid to form a mixture; and
adding a material containing resin and a surfactant containing both lipophile and hydrophile into said mixture and making them well mixed to form said adhering agent.

10. The method according to claim 1, wherein said moisture-adjusting agent is less than 2% of said clay by weight.

11. A clay that contains lignocellulose, said clay comprising:
a first feed that contains lignocellulose;
a second feed that contains a soft material;
a third feed that contains powdery adhesive;
an adhering agent, being used to enhance the adhesion function of said third feed; and
a moisture-adjusting agent, being used to accelerate moisture evaporation to control the shaping time of said clay.

12. The clay according to claim 11, wherein said first feed is 24%-39% of said clay by weight.

13. The clay according to claim 11, wherein said second feed is 18%-24% of said clay by weight, nd said soft material in said second feed has plenty of amylum.

14. The clay according to claim 11, wherein said third feed is more than 4% of said clay by weight.

15. The clay according to claim 11, further comprising a fourth feed that contains a clay material, wherein said fourth feed is 0%-30% of said clay by weight.

16. The clay according to claim 11, further comprising a hardness-adjusting agent that makes said clay spontaneously get hard, through which to adjust the hardness of said clay, wherein said hardness-adjusting agent is 0%-3% of said clay by weight.

17. The clay according to claim 11, further comprising a hue-adjusting agent that makes the hue of said clay lighter or darker, wherein said hue-adjusting agent is 0%-5% of said clay by weight.

18. The clay according to claim 11, wherein said adhering agent is 35%-45% of said clay by weight.

19. The clay according to claim 11, wherein said adhering agent further comprises:
a material that contains amylum;
a material that contains resin; and
a surfactant with both lipophile and hydrophile.

20. The clay according to claim 11, wherein said moisture-adjusting agent is 0%-2% of said clay by weight.
